(19) United States
(12) Patent Application Publication
(10) Pub. No.: US 2007/0278975 A1
(43) Pub. Date: Dec. 6, 2007

(54) Method and Apparatus for Transforming Wave or Field Alternations Into Repetitive Thrusts

(76) Inventor: Chris Tsikoudas, Thessaloniki (GR)

Correspondence Address: K.F. ROSS P.C., 5683 RIVERDALE AVENUE, SUITE 203 BOX 900, BRONX, NY, 10471-0900, US

(21) Appl. No.: 10/592,397

(22) PCT Filed: Jan. 13, 2005
(86) PCT No.: PCT/GR05/00001

§ 371 Date: Jun. 13, 2007

(51) Int. Cl. H05H 9/00; G21K 1/00

(52) U.S. Cl. 315/501

(57) ABSTRACT

The subject of this invention is a method and apparatus of transforming consequent wave or field alternations into repetitive unidirectional thrusts in a synchronized manner. In the general classical version of the principle, the magnetic part of an appropriate coherent electromagnetic wave is synchronized to interact with appropriately prepared cyclic or oscillatory motion of charge. This produces repeated deflection thrusts pushing the charge toward a precise average direction. The principle may apply at the border of quantum physics, particularly under certain transitional cases. An apparatus is also provided that allows the principle to apply in many adjacent wave antinodes. The part of the wave that has participated in the interaction may carry non-classical attributes, which the method produces. The general principle may operate with other kinds of waves as well, for example with sound waves providing unidirectional synchronized thrusts upon revolving surfaces.

### BACKGROUND OF THE INVENTION

1. Field of the Invention

The subject of this invention is a method and apparatus of transforming consequent wave or field alternations into repetitive unidirectional thrusts in a synchronized manner. In its general classical version, the magnetic part of an appropriate coherent electromagnetic wave is synchronized to interact with appropriately prepared cyclic or oscillatory motion of charge, producing repeated deflections forces that push the charge toward a certain average direction. The principle may apply at the border of quantum physics, particularly under certain transitional cases. An apparatus is also provided for applying the principle upon neighboring wave antinodes. The part of the wave that has participated in the interaction may carry non-classical attributes that the method produces. The general principle may apply with other kinds of waves, for example with sound waves used to exert unidirectional forces on rotating surfaces of appropriate shapes.

2. Description of Related Art

The novelty does not concern an improvement or extension of a prior method, hence there is absence of precise prior art. There may however be very loose reference to similar types of synchronized interactions.

For instance, the principle may refer very loosely even to the way an electric engine makes use of the alternation in current in providing motion to the rotor, subject to obvious substantial differences like that instead of polarity alternation in coils we here have a wave's field alternation and that the resulting motion is not limited to turning a rotor.

Even though the principle on which this invention is based is classical, in certain cases, mainly transitional, it may also operate at the border of quantum physics. In terms of achieved motional result it may therefore compare loosely to techniques of moving individual charges or atoms by laser beams or due to coupling between individual atoms and small cavities.

Moreover, since the principle of this invention may also apply with other kinds of waves, for instance sound waves, that may get to push revolving surfaces, prior art may loosely compare to existing methods of pushing microstructures.

The diverse applicability of the principle of this invention opens up room for applications in areas that may include displacement/propulsion of charges or whole atoms or structures, opto-electronic operations, creation of signals carrying non-classical attributes, and synchronous manipulation of wave energy in general.

### BRIEF DESCRIPTION OF THE DRAWINGS

FIG. 1 shows in a simplified fashion the step-by-step interaction between a charge (1) and two fields, an electric field (2) and a magnetic field (3) that are rotating at perpendicular planes. The charge follows a circular path (4) that may be driven or triggered by the action of the rotating electric field, where this electric field can correspond to an electric antinode of a standing electromagnetic wave oriented in the ZZ′ direction (not shown). While the charge circulates, the rotating magnetic field (3) applies from a perpendicular direction, where this magnetic field can correspond to a magnetic antinode of a standing electromagnetic wave oriented in the YY′ direction (not shown). According to the desired synchronization between′ the two standing waves, at each step of the interaction's cycle the charge moving in the direction (5) is influenced by the rotating magnetic field (6) and is deflected sideways (7). At different points of the cycle the magnitude and direction of the deflection force is different, but throughout each cycle the charge receives two deflection kicks roughly averaging in the direction XX′. This interaction can also involve another charge of opposite sign (9) where the two charges form a dipole.

FIG. 2 shows schematically an apparatus comprised by a cavity that may support the formation of a standing wave between an upper (10) and a lower (11) reflector, and respectively another standing wave between a left (12) and a right (13) reflector. Within this apparatus there lies a medium (14) upon whose charges the principle applies, however there develop regions where the localized deflection kicks head in opposite directions; If charges within regions “A” and “C” are forced in the one direction (15), charges within regions “MB” and “D” are forced in the opposite direction, so special measures are to be presented for the forces not to cancel out each other.

FIG. 3 shows a version of the principle concerning a synchronized interaction between a flat surface (16) rotating around an axis (17), and a travelling sound wave (18). The sinusoidal representation schematically describes the sound wave's parts that provide “push” and “pull” action. Under proper synchronization each “push” part of the wave meets the surface at right angles so that it exerts a push on it (part A), while each “pull” part meets no effective surface since the surface has meanwhile turned by 90° and is parallel to the direction of propagation of the wave (part C). As a result the surface repeatedly receives only forward and no backward kicks (or vice versa).

### DESCRIPTION

The subject of this invention is a method and apparatus of transforming consequent wave or field alternations into repetitive unidirectional thrusts in a synchronized manner. In the most general version of the principle, the magnetic part of an appropriately prepared coherent electromagnetic wave is synchronized to interact with appropriately prepared cyclic or oscillatory motion of charge. This produces repeated deflection kicks, pushing the charge toward a certain average direction. Hereunder it is first presented the general version of the principle in a classical frame, and this is followed by descriptions of embodiments operating at the border of classical and quantum physics.

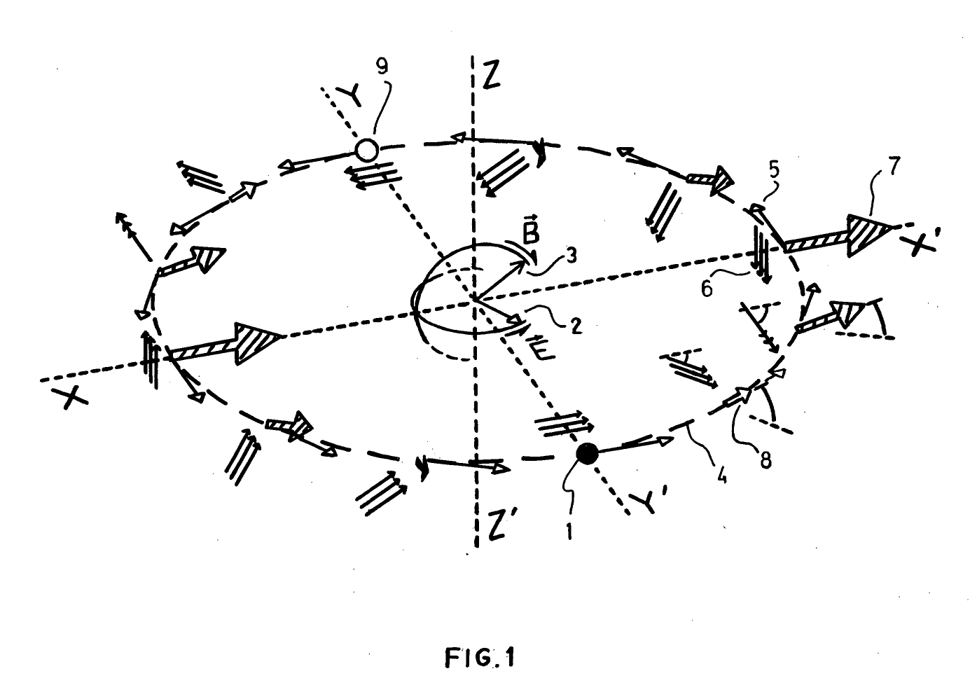

FIG. 1 shows in a simplified way the step-by-step interaction between a schematically depicted charge (1), an electric field (2) that drives or triggers the charge's appropriate motion, and a magnetic field (3) that delivers the synchronized deflection kicks according to the principle of this invention. The charge follows a circular-like path (4) caused by the action of the rotating electric field whose vector rotates on the X-Y plane. In the classical case the charge's circulation follows the phase of the driving electric field, subject to some phase lag. [Re: “Feynman's Lectures on Physics”, volume III, page 17-10]. In one non-limiting case this electric field can correspond to an electric-field antinode of a circularly polarized coherent standing electromagnetic wave formed in the ZZ′ direction, but other means of achieving circular-like motion of charge may also do. While the charge circulates, a rotating magnetic field (3) is applied from a perpendicular direction (the magnetic field vector rotates on the X-Z plane) with rotational frequency that matches the frequency of the charge's circulation. The desired phase synchronization between the charge's circulation and the rotation of the magnetic field vector is as shown in FIG. 1 in a time-progressive fashion. At each instant, the cycling charge moves tangentially (5) and it is influenced by the momentary action of the rotating magnetic field (6). For the magnetic field to be able to act without a damaging involvement of the substantially stronger electric field, the action of the later may be squeezed-down by interference, but this will be described later. The cross-product interaction between the charge's motion vector and the momentary magnetic field vector yields a sideways deflection force (7). At different points of the cyclic path the magnitude and direction of this deflection force is different. For instance when the charge passes from the location shown at (1) the cross product of the magnetic field's vector and the charge's velocity vector yields a zero force. A little later the charge has moved counter-clockwise by about 30 degrees and the magnetic field has also rotated so a deflection force starts to act upon the charge, pointing outward-and-up with respect to the cyclic path (8). As the charge keeps moving toward the 90 degrees of its cycle the force gets stronger and points closer to the X-Y plane. The deflection force is strongest at the cycle's 90° whereat it points in the X-X′ direction (7), then again it starts diminishing and pointing out of the X-Y plane. Later it reaches another maximum at the 270° of the cycle whereat it points in the X-X′ direction once again. Under this setting, therefore, the charge receives two deflection kicks per cycle (one while it moves through the Y′X′Y arc and one while it moves through the YXY′ arc) roughly averaging toward the general direction X-X′. Over a number of cycles, the path that the charge is forced to follow may be understood to look roughly like a sideways-flattened spiral (periodically getting a little above or below the XY-plane). The magnitude of the deflection's step in each repetition depends on the strength of the interaction, and because in the ordinary case the magnetic kick is weak special measures are indicated later for the method to improve outcome. The described interaction keeps taking place for as long as the system remains itself in proper synchronization and the charge lies within the range of action of the described magnetic field. The interaction can also take place in opposite phase and deliver thrusts in the opposite direction. Or if the charge has no freedom to shift toward the forced direction, then the thrust may be conveyed to the frame that houses the charge.

Like the principle in the classical context has been described to apply upon a charge, it may similarly apply upon a hole, or upon an ion, or upon a charged body. Likewise it may also apply upon a collection of charges or holes, provided that they remain bunched up within synchronization and keep within the range of action of the involved fields. Moreover, the subject of this invention also covers the case where the deflection thrusts are affected on dipoles. FIG. 1 illustrates a dipole's case where, along with the charge passing from location (1) there is another charge of opposite polarity that passes from location (9), so that the two opposite poles move in opposite tangential direction with respect to each other. As a result they are both deflected toward the same direction (provided that the distance between the two poles of the dipole is much smaller than a half-wavelength of the beam mode supplying the rotating magnetic field). Yet if the one pole is much more massive than the other it will circulate at a considerably smaller radius in which case the smaller tangential velocity implies weaker magnetic thrust.

It is also within the subject of this invention variations concerning different field polarizations and ways to affect the magnetic action. For instance the magnetic field can originate from a linearly polarized standing wave (of sufficient photon density so that classical conditions apply). The later wave can be formed in the YY′ direction or another direction on the X-Y plane so that the magnetic field vector alternates in the ZZ′ direction (instead of rotating on the X-Z plane). This version of the principle can again produce deflections averaging in the XX′ direction, while the deflection forces are contained within the X-Y plane. In yet a different example that concerns interactions synchronized at the microwave or lower frequency, the magnetic field that provides the thrusts could arise by an alternation in current.

It is also within the subject of this invention variations concerning alternative ways to create the necessary charge motion. For instance, provided that classical conditions hold, the electric field vector that drives the motion of charge can be alternating linearly in the horizontal YY′ direction instead or rotating in the X-Y plane. In such case the charge will oscillate back and forth in the YY′ direction, and two sideways thrusts will be produced again by the principle of this invention per oscillation cycle. In yet another case, if some particular wave mode and angle of incidence is found to allow for a single beam to provide for both the necessary electric and magnetic fields, this would make it possible for this wave to drive the motion of charge and in parallel to provide the unidirectional thrusts. Or in still another totally different case, a cyclic motion of charge could be obtained via the action of a permanent magnetic field upon a moving charge (instead of using the action of a rotating electric field) though in such case it would be hard to maintain synchronization.

Departures from the optimum angle of incidence for either one of the two intersecting beams may be acceptable by trading the outcome, for instance the standing beams could be intersecting each other at a non-optimal angle (within limits) in which case the method would still operate sub-optimally. Also, in the ordinary case the electric field of the beam that is to provide the magnetic deflections affects charge a lot stronger than the magnetic field itself. (Except if in an application the magnetic field originates form a low-frequency alternation in current, or in the other extreme, if relativistic conditions hold). This may require the application of destructive interference to locally squeeze down the action of the electric field, to the benefit of the action of the magnetic field (upon the spot of interaction). One way to create such squeezing or cancellation is by having the said beam to be a standing one. For a standing beam it holds that upon the reflectors and in equally spaced nodal points in-between there form electric field nodes, and at the same time these nodal points constitute magnetic field antinodes. Likewise, magnetic field nodes (formed a quarter of a wavelength away from the beam's electric nodes) correspond to electric field antinodes. In other words the formation of standing waves allows for some sort of separation between the action of the electric and magnetic fields simply because at the electric antinodes the magnetic field almost cancels out, while at the magnetic antinodes it is the electric field that almost cancels out.

One can then arrange for the charge (or charges) that is candidate to participate in the interaction to lie in a particular location with respect to each of the orthogonal standing beams: With respect to the one beam, like the vertical one of FIG. 1, to be located in an electric field antinode. (This may be unnecessary when the magnetic action of the same beam is negligible, yet it may become necessary if the principle applies on more than one neighboring spots, due to each beam's dual action that will be described later). With respect to the other standing beam the charge should lie in a magnetic field antinode (which is concurrently an electric node) so that it receives the synchronized magnetic deflections without a damaging involvement of the same beam's electric field.

The formation of standing waves can take place by the use of a resonant cavity, offering advantages relating to stability, to shielding from external influences, to facilitating amplification of the beam inside the cavity if necessary. To form a standing wave it is not however imperative to use a cavity, since a standing-wave pattern can also form by employing two travelling counter-propagating beams. In the later case however the synchronization has to be achieved by adjusting the frequencies and phases of the beams, which also relates to fixing the nodes spatially, and it is generally hard to maintain the beam's phase coherency characteristics for long distances or time. Consequently the later alternative could be limited mainly to high-energy applications where photon reflection becomes hard so a conventional cavity is not possible to use.

The description of the principle of this invention so far seems to ascribe better to conditions involving a large number of photons and to charges behaving in a classical context, like for example in dealing with free electrons. Yet the general principle and its variations is not restricted to applications where charge oscillations are strictly classical and ideal. Instead it may apply in certain quantum circumstances approximating the classical model. For instance one such quantum circumstance may concern the effective charge motion in localized electronic states in atoms, which correspond to non-stationary wave packets comprised by coherent superpositions of quantum states, for example adjacent high-n Rydberg states. The stability of the wavepackets is achieved by the continuous application of a circularly polarized electric field (or in combination with a magnetic field), and the wave packets move along classical-like orbits or other specified paths for certain time windows without spreading so they may behave as analogs of the coherent states of a harmonic oscillator.

The principle may also apply on charge during atomic or molecular transitions or transitions of spatially confined charges. According to theory the dipole moment of an atom in a definite energy state is zero so one may not interpret the electron's angular momentum as a form of circular-like motion. But when the atom is in the mixture of two quantum states, its charge distribution oscillates at precisely the frequency of the photon emitted or absorbed. The simplest aspect of the atom's charge distribution that can be oscillating is the electric dipole moment (without limiting the application of the principle on this only). According to quantum mechanics this is the product of the electron charge and the expectation value of its displacement vector from the essentially fixed massive nucleus, and this statistical quantity can account for charge motion. Quantum electrodynamics explains that for the case of emission the radiating atom gets into the mixed state through a resonance interaction that induces the charge oscillations of that frequency which are characteristic of the mixed state, and the atom emits electromagnetic radiation of the same frequency. For the invention to make use of the corresponding oscillation of charge, the magnetic kicks should apply at correct synchronization with the stimulated transition while this transition takes place.

Two issues involved here are if the involvement of the uncertainty principle does or doesn't allow the achievement of the necessary synchronization, and second if a charge can indeed be kicked by the beam's magnetic field while it performs a transition. The uncertainty principle does not allow to know the exact time that the transition will take place and its exact energy (or to know the position and momentum of the oscillating charge), but this is possible to get through by the fact that the transition is stimulated: While the exact time that the target atom will perform a stimulated transition is not known, one can rely on the fact that whenever this transition will happen, its phase will match the phase of the triggering photon. So by extend it will also match the phase of the whole coherent beam that supplied the triggering photon. Therefore the uncertainty principle does not prohibit the achievement of the necessary synchronization. That a charge is possible to be kicked while it performs a transition is observed in experiments in quantum electrodynamics. In this respect candidate transitions can be chosen according to characteristics like their energy, spatial localization and orientation, or extend in time. (In high-energy cases certain electrons may be stripped out, in which case the method should operate at the natural frequency of the ion). Moreover, the use of a resonant cavity increases the rate at which an atom performs coherent transitions (whereupon the principle of this invention may apply), since the resonant cavity may enhance a particular transition and suppress transitions at other non-integral half-wavelengths along this direction. The cavity being extra small it may additionally assist in faster repetition of the interaction (as in “Rabi” oscillations), since the repetition frequency depends on the size of the cavity (among other factors like the transition energy and the size of the atomic dipole).

Like the method is described for the case of photon emission, it may similarly apply on charge oscillations that take place during photon absorption. A way to impose synchronization in this case is to let only coherent photons be around in the vicinity of the atom, so the chances are that the absorption will match the coherent phase of the photons no matter when it happens. The application of the principle during absorption is however harder to maintain in time because the coherency in such a setting may be damaged as soon as few spontaneous re-emissions of photons will create further emissions at wrong phase. To run the principle for long times it is therefore important that the operation parameters (like frequency or temperature) keep the rate of spontaneous re-emissions low.

Like the principle of this interaction has been described to work with atomic transitions, it may similarly apply on molecular transitions. For instance rotational transitions relate to the dipole rotation as the one depicted in FIG. 1, vibrational transitions correspond to the aforementioned version involving linearly polarized fields, while electronic transitions are similar to those described for atoms. Moreover, the subject of this invention may similarly apply upon quantized transitional oscillations of artificially confined charges, or—in principle—even upon nuclear charge oscillations.

For the sideways kicks to be delivered on an oscillating charge, conservation of momentum demands for opposite forces to be exerted somewhere else. For an interaction like the one described in FIG. 1, the rotating magnetic field applies a force when its vector points in the neighborhood of the Z direction, and does not apply force when its vector points in the X direction. Observation of the interaction's forces as shown in FIG. 1 reveal that during every half cycle (arc YXY′) the circulating charge is like being pushed to circulate at a smaller radius, and during the other half (arc Y′X′Y) it is like being pushed to circulate at a larger radius. As a result the supposedly circular-like motion of the charge tends to become an ellipsoidal-like one (a deformation toward the direction where the kicks are delivered). In this ellipsoidal-like path, the part where the charge's circulation radius decreases (during approximately one half of the cycle) is like the charge's circulation frequency being increased, while during the other half where the radius increases it is like the frequency being decreased. Here the magnetic action apprehends the charge's deflection as a “load” (something analogous to the mechanical load on an electric engine's rotor) thus the alternation in the deflection force over each cycle translates into an alternation in the load the acting wave is subject to. (Particularly if the kicked electron is bound to an atom or other system whereupon it delivers the thrust, then the effective “load” may correspond to the whole atom or system being pushed). From the theory of electric engines it is known that the mechanical load an engine is subject to relates to an inductive shift between the current and voltage oscillations, and a corresponding change of part of the power into reactive. While in the present invention we have an on-going alternation in the load the wave is subject to (while providing consequent deflection thrusts), this corresponds to an oscillating transformation of power from real to imaginary. The imaginary part of the complex function now describing the wave may correspond to what is referred to as an evanescent mode. (According to theory this mode bears the peculiarity that the wave may be recovered at a nearby point having traversed the distance in-between at extraordinary high speed). It is therefore within the subject of the invention the use of the principle as of above in creating this mode of wave (independently to where it is recovered).

In such case, by imposing an amplitude or frequency modulation to the beam that applies the magnetic thrusts, and therefore modulation to the strength or duration of each deflection thrust, we may have the formation of an evanescent mode containing a signal. In this respect it is also within the subject of this invention the use of the main principle as a method of producing signal in an evanescent mode. (An inverse process would then recover this signal at a different spatial point).

In embodiments where circular photon polarization is used for preparing the necessary charge motion, photons should have only certain polarization per direction in the cavity (constituting a circularly polarized wave), or otherwise the right-hand-circular (RHC) polarized photons may need to have a phase difference equivalence with respect to the left-hand-circular (LHC) polarized ones, for example 180°, for the magnetic kicks relating to the two circular polarizations not to cancel out each other. This issue may actually concern both perpendicularly intersecting standing beams.

When adopting a certain polarization per direction, one can choose the option to get the initial coherent source-beam pass through a filter that separates between RHC and LHC polarized photons. In this case the RHC polarized ones can be directed to constitute the one of the two intersecting standing beams and the LHC polarized ones the other. (This may hold even in a case where beam amplification is to happen within the cavity).

For thermal fields not to degrade the synchronicity of the interaction due to local Doppler effects, the temperature should be kept as low as each specific application requires, and in specialized cases there may be need for atomic cooling techniques. High vacuum environment may also be in need in specific applications, while quantum confinement could also be an alternative for restricting charges to only certain quantized states of motion. Optical effects should be kept within limits for not to degrade or destroy the phase synchronization between the intersecting beams. Regarding the possibility of a Zeeman effect involvement due to the action of the alternating magnetic field of the beam that provides the kicks, the field alternation is very fast for developing a lasting detuning that would damage the synchronicity of the process. If however an external magnetic field is used, for instance in maintaining atomic orientation, then the method should be synchronized at a Zeeman frequency.

Another issue of concern is that since the atom lies at the intersection of two perpendicular standing beams of almost identical energies, there exists a possibility that it is triggered into a stimulated emission by the not-wanted beam. For example, if an atom's orientation axis has a component parallel to the reflector's surface, the atomic dipole acquires a component that makes it vulnerable to a transition along the perpendicular cavity. In this case a transition triggered by a photon of the not-wanted standing beam is unlikely because the not-wanted beam forms an electric node at the spot where the candidate atom lies. (That is, the counter-propagating beams constituting the not-wanted standing beam interfere their electric fields into cancellation). But even when such an unwanted transition may rarely happen, no “wrong” deflection force is exerted upon the transitioning charge, since the magnetic field forms a node upon the spot where the charge lies. It is just that the synchronous interaction that would normally kick the transitioning charge has been missed since the “wrong” beam acted, and the atom will have better chances to have its transitioning charge be pushed in its next transition. Generally, for avoiding unwanted cavity transitions it is of reason to use appropriately oriented atoms (to be accomplished by any method of art or possibly by utilizing a material's natural characteristics).

In actual applications, within each particular spot of interaction (having the range of an antinode with respect to each of the two orthogonal beams) there may lie numerous individual charges that are subject to receive deflection kicks (instead of just a single charge). In conditions of low density of such charges and not-strong acting beams, these charges may receive the kicks relatively independently from each other. In the contrary, in a case of strong fields or/and higher density of charges, the charges may bunch up and participate in the interaction more collectively.

In actual applications the spatial cross-section of the intersecting beams may have a larger width than one antinode, so the interaction may be taking place on charges lying on more than one adjacent antinodes (provided that the medium housing the charges of interest is accordingly large). In such cases each electric and magnetic antinode of either standing beam will exert their own influence upon candidate charges. This can bring an unwanted result that on adjacent spots the deflection kicks point in opposite directions and cancel each other, hence special measures may be in need to counteract the opposing forces.

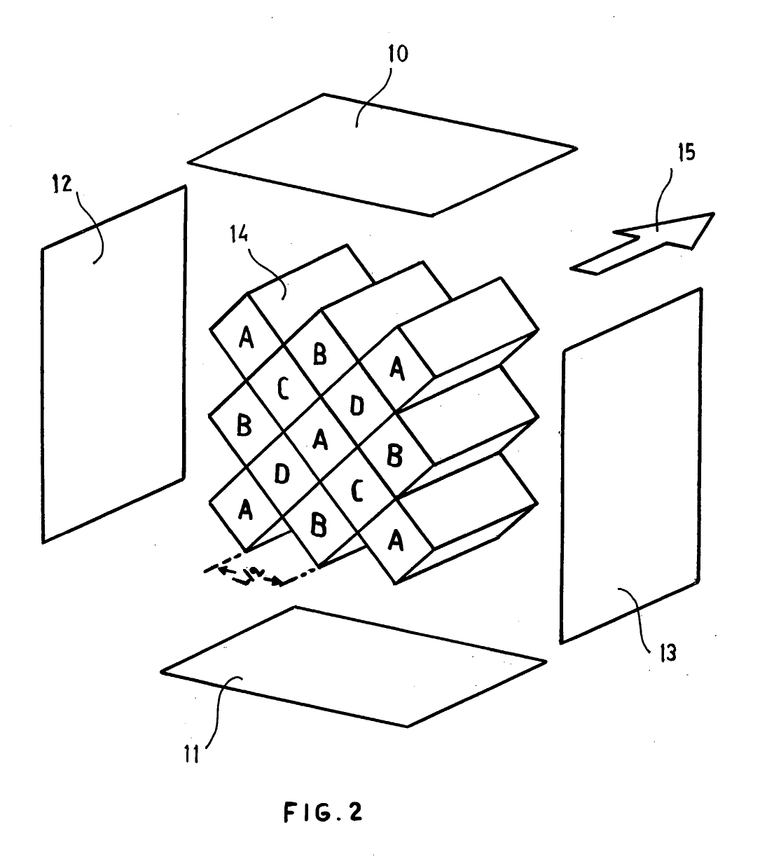

In FIG. 2 there is drawn an apparatus consisting of a cavity supporting the formation of two standing electromagnetic waves (not shown) orthogonally to each other, one between the depicted upper (10) and lower (11) reflectors (ZZ′ direction), and one between the figure's left (12) and right (13) reflectors (YY′ direction). Inside this cavity there lies the medium (14) containing the charges whereupon the principle of this invention is to take place. Depending on the application, the charges might either be, or not be, fixed to the medium, and the medium might be or not be fixed to the cavity frame. In one non-limiting case, for instance, the medium may consist of a lattice-like structure of atoms/molecules and the principle could apply on specific atomic/molecular charges of this structure. Or in another instance it could consist of free charges, like for instance charges of a plasma-like gas of low density. When charges have motional freedom the kicks may produce a current (through an external loop or internally to the medium), or if the charges don't have motional freedom the kicks may be conveyed to the medium as a whole. Through further development of this invention there may also be a possibility to have the whole apparatus being kicked by liberating a beam that has participated in the interaction and managed to escape the cavity without delivering a reaction force on it.

In the depiction of FIG. 2 the size of the cavity is just schematic, but the particular distance between regions “A” and regions “B” of the medium (per each orthogonal direction) equals one-half wavelength. External synchronized beams may enter the interaction region (for instance through partially transparent reflectors) and form standing waves, or beam amplification could take place inside the cavity itself. Regions “A” and “B” correspond to places of the medium where the vertical standing beam forms its electric field antinodes and the horizontal standing beam its magnetic field antinodes. Charges lying in regions “A” at the four extreme corners of the drawn medium (excluding region “A” at the center) are exactly one wavelength apart from each other (with respect to either standing beam), so the field components of both beams have same phase at each instant. As a result the kicks delivered in all these four regions are unidirectional, averaging—say—toward the direction XX′ (15). (At the heart of each of those regions the antinode peaks so there are better chances for charges to carry out a desired transition and the magnetic deflection achievements are also greater, while near the nodes they are weaker). Regions “B” lie exactly in-between the four cornered regions and thus L/2 apart from those, as indicated in the figure (where L is the standing wave's wavelength). So depending on the location of each “B” region, either the electric field of the vertical beam or the magnetic field of the horizontal beam is at opposite phase (at a negative antinode). As a result, in all “B” regions the deflection kicks net in the direction X′X (opposite to the direction of forces at the four “A” corners). Exactly at the center of the drawn lattice there is a region that is also named “A”, where both the electric field of the vertical beam as well as the magnetic field of the horizontal beam have opposite phase (than that at the four corners). Because of this, the resulting kicks of this region are heading toward the same direction as they do in the four “A” corners, the direction XX′. As regards to areas located exactly in-between regions “A” and “B” (in straight, not in diagonal) either one of the affecting fields is on a node. This means that either no charge oscillation is induced/triggered (this holds in roughly one-half of these spots) or no magnetic field is there to provide the deflections (for the other half of the spots), so in either occasion no deflection kicks are exerted. The overall result described this far is therefore that regions “A” receive opposite kicks than those their neighboring “B” regions do, so the corresponding large medium would be unable to move toward either direction.

The above regions are not the only ones in effect. The vertical beam's electric field nodes are concurrently magnetic field antinodes, and the horizontal beam's magnetic field nodes are concurrently electric field antinodes. Taking into account the additional interactions by the electric action of the horizontal beam and the magnetic action of the vertical, there arise similar deflection kicks in regions “C” and “D” (lying diagonally in-between the previous “A” and “B” regions). Regions “C” and “D” are again L/2 apart from each other, and for same reasons as the ones described previously, charges in regions “C” are being kicked in opposite direction than the one charges in regions “D” do. If for instance regions “C” are pushed in the same direction with regions “A”, then regions “D” are pushed in the same direction with regions “B”, and this leads to the formation of layers of opposing forces. If the one layer is made up by regions “A-C-A-C- . . . ” and is kicked in the direction XX′, then the other layer is made up by regions “B-D-B-D- . . . ” and is kicked in the direction X′X. Such opposing forces, in spots or in layers, may find particular use in specialized applications, like in creating special resonances in certain processes or possibly in opto-electronics. Since however in the majority of applications the opposing forces constitute an obstacle in achieving collective motional results, special measures are required to overcome them. Moreover, if the interaction were designed to operate at a higher TEM mode than the fundamental, one would have to face the formation of the opposing forces at denser range (unless a particular modal adjustment manages to counteract the opposing forces over a region).

To overcome the opposing forces, one alternative is to use a specially prepared medium, in which regions “B” and “D” (and therefore the layer B-D-B-D . . . ) are transparent (inactive) at the beams' frequency, leaving “active” only regions like “A” and “C” (layer A-C-A-C . . . ) whereupon unidirectional forces apply. No matter the way chosen to affect transparency or activeness (like by having charges engaged in some particular excitation, or having certain atomic charges withdrawn, etc) the layers' indices of refraction should have similar values and the change between layers should be smooth enough for the beams not to be reflected or refracted. Another alternative is if atoms in regions “A” are prepared to be susceptible to triggering by photons of certain circular polarization, while regions “B” are prepared to be susceptible to triggering by photons of the opposite circular polarization, and the same could hold for regions “C” and “D” with respect to the horizontal beam. Adjustment of the phase difference between the involved circular photon polarizations could get the kicks in regions “A” and “B”, or/and in regions “C” and “D” to be pointing in the same average direction.

Another option is to have the medium prepared to contain candidate charges (for the application of the principle of this interaction) only on very particular spots that serve specific purposes, for example only on spots where the deflection thrusts are to be unidirectional without having to take other measures (like only on spots “A” and “C”), or spots where the electric and magnetic fields yield their maximum, or spots where the acting fields are subject to a specific phase difference between them (for instance due to a phase lag in the charge's respond to the driving action of the rotating electric field).

Possible uses of the principle as presented above may include transformation of electromagnetic wave energy into current (through an external conduction loop, or internally to the medium in mini-loops, or in control of charge motion in boundary effects). At higher energy and strong fields the method may push ions or even let an apparatus move in outer space by forcing away such ions. Through additional processing the principle of this invention may also be used for the utilization of the energy of solar light (first passed through a prism and then through a phase controller so according to frequency and phase of photons it is driven to interact at different nano-scale cavities). Operating the principle on more than one frequencies concurrently could also lead (through further development) to uses in opto-electronic relaying or computational multi-switching. Moreover, the principle may be used to generate waves in evanescent mode, providing the emission means for extra fast communication.

A still different version of the principle that lies within the subject of this invention concerns the case when the principle applies on resonant oscillations of charges of same polarity. For instance when charges are neither completely bound to atoms nor adequately free from surrounding influences (as conduction electrons are), they can participate in resonant oscillations either directly or via the mediation of other surrounding charges. During such resonant oscillations charges carry out movement in opposite directions, so according to the principle of this invention the magnetic field exerts opposite kicks on each of them. One possible use of this version of the principle may be the influence of chemical or physical processes by exerting deflection kicks in specific particles or spots or stripes, either directly or through the creation of mini-currents. Or in another possibility, this version of the principle may be applied upon pairs of nuclei that have been brought to sufficient proximity so as to respond and exhibit absorption energies, whereupon it could let a resonant oscillation build up locally and assist in a “mild” overpass of the Coulomb barrier. The principle could also possibly apply in elongating the lifetime of certain superheavy elements where the nucleus deformation seems to play a significant role in their stability; An oscillation of the deformation via use of the principle of this invention would facilitate a gentle spread of energy that would otherwise lead to instant decay, thus favoring the elongation of the corresponding particles' lifetime.

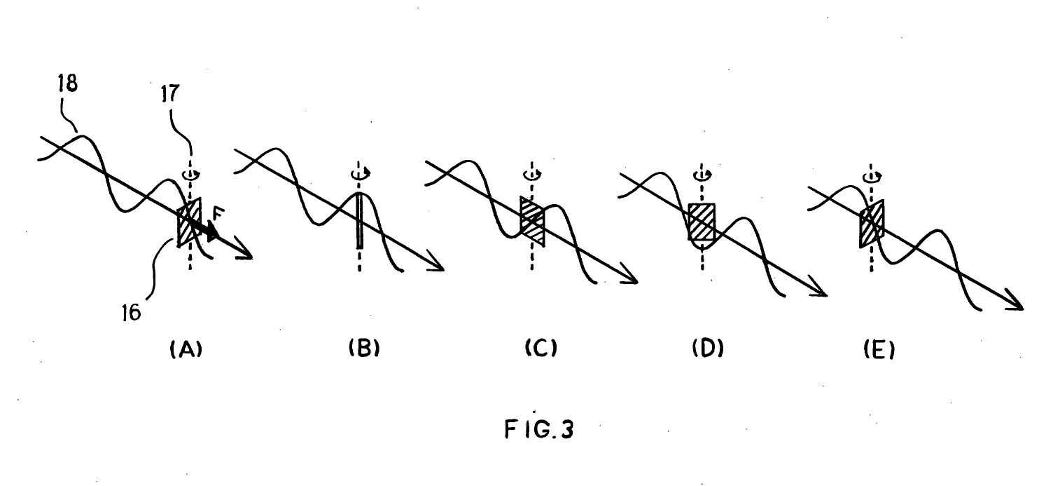

Yet another version of the principle of the present invention concerns the utilization of the wave energy of individual oscillations of mechanical waves, for example sound waves interacting with revolving objects. FIG. 3-A shows a flat surface (16) rotating around an axis (17), and being surpassed by a sound wave (18). Consider the sinusoidal representation of the travelling wave to represent the fronts of the sound wave's alternations. When the media's molecules are moving forward (toward the direction of the wave's propagation) they push the surface along (part A). In part B the figure describes the situation an instant later, where the wave has propagated a distance of ¼ wavelengths and concurrently the surface has rotated by 45°. Here the sound wave does not push the surface since the media's molecules are momentarily at rest. A further instant later (part C) the media's molecules are moving backward and the wave would normally pull the surface backward, but this doesn't happen because the surface has now completed 90 degrees of turn so it shows no active surface to the wave. As a result, the pull-part of the wave surpasses the surface ineffectively. Still one instant later (part D), the wave has moved forward by ¾ of a wavelength, and no forces are acted upon the rotating surface since the medium molecules are momentarily at rest once more. Then the interaction is starting to repeat itself (part A). In this simple case the sound wave is pushing the surface by utilizing periodically only the respective push-part of the wave's energy. If the interaction takes place with a phase difference of 180 degrees then the surface will be subject to repeated pulls instead of pushes.

The later version can come in variations and improvements, for instance the surface (supposedly rotated by a motor) can optionally be curved—the curvature having the radius of revolution—for the purpose of avoiding the creation of turbulence in the media that transports the wave. Furthermore, the sound wave could be subject to a process of focusing, for the rotating surface to utilize a larger part of its energy.

For the thrusts to be delivered by a sound wave on the rotating surface, opposite forces need to be exerted somewhere else for momentum to be conserved. Immediately after the wave has participated in the interaction it exhibits a local partial “rectification” (like a diode rectifies an alternating current). This happens since only the push-part or only the pull-part of its oscillation has been exploited. This modulation, subject to diffusion, conveys an opposing (reaction) force to whereupon it falls. The later can be transmitted better inside a waveguide, so that a large percentage of the “rectified” wave front is better maintained. The waveguide's orifice may also be shaped such as to focus the modulated wave as it exits the tube. This method of producing “rectified” mechanical waves also lies within the subject of this invention.

It is also within the subject of the invention extrapolations of the principle involving still other kinds of fields. In one example, an oscillating electric field can act on a spot traversed alternatively by positive and negative charge, or alternatively by charges and holes, or by charged particle waves alternatively interfering constructively and destructively. Provided a synchronization where positive field acts on positive charge and negative field on negative charge, or vice versa, this could have the electric field deliver unidirectional kicks upon the exchanging (alternating) charges.

Still, it is within the subject of this invention extrapolations concerning the exploitation of wave energy in exotic interactions. For instance a non-limiting extrapolation may concern the creation of synchronized deflection thrusts where a “sideways” deflection force may refer to “orthogonal in extra dimensions” (dimensions beyond the conventional four), even though in the classical world this might project (become perceivable) as some sort of an internal force, like possibly a spin-related force or another quantum force or a negative-energy force or even a force relating to the weak interaction.

1. Method of transforming consequent wave or field alternations into repetitive thrusts heading toward the same average direction.

2. The method according to claim no.1, wherein a rotating or oscillating magnetic field is used to provide synchronized deflection kicks upon circular-like moving or oscillating charge or charges, or correspondingly holes, ions, or charged bodies.

3. The method according to the above claims, wherein the magnetic field used to provide the kicks is a constituent of an electromagnetic wave.

4. The method according to the above claims wherein interference is used to locally squeeze down the action of the wave's electric field to the benefit of the action of the magnetic field at the spot of interaction.

5. The method according to the above claims wherein the required cyclic or oscillatory motion of charge(s) is driven or triggered by the electric field of an electromagnetic wave.

6. The method according to the above claims wherein the required motion of charge corresponds to charge behavior during transitions, for example transitions between energy states of atoms or molecules or spatially confined charges.

7. The method according to claims no. 1-4, wherein the required motion of charge corresponds to motion of non-stationary wave packets comprised by coherent superposition of quantum states.

8. The method according to claims no. 1-4 wherein circular motion of charge is produced by the action of a permanent magnetic field on a moving charge.

9. The method according to the above claims wherein the principle is applied on more than one neighboring spots by utilizing more than one antinodes of the acting waves.

10. Apparatus for the application of the method according to the above claims, wherein it accommodates two standing electromagnetic waves intersecting each other (or another particular wave mode that brings an analogous result) and upon the region of their intersection there lies an appropriate medium that contains the charges that are candidates for being subject to deflection thrusts.

11. The apparatus and method according to the above claims, wherein the medium is made by alternating regions or layers, one active—the next inactive (transparent) and so on, thus allowing to overcome the creation of opposing thrusts.

12. The apparatus and method according to claims nos. 9-10, wherein the medium is made by uniform material, for the principle to produce alternating opposing forces within itself.

13. The apparatus and method according to the above claims, wherein the RHC and the LHC polarized photons have a phase difference between them, for instance 180 degrees, for their magnetic kicks to act without canceling each other.

14. The method and apparatus according to the above claims, wherein photons first pass through a polarization filter so that photons of the one circular polarization are supplied for the formation of the one standing beam, and photons of the other circular polarization are supplied for the formation of the other standing beam.

15. The apparatus and method according to the above claims, wherein the medium contains candidate charges (for the application of the principle of this interaction) only on very particular spots that serve specific purposes, for example only on spots where the electric and magnetic fields yield their maximum, spots where the acting fields are subject to a specific phase difference between them, or spots where the deflection thrusts are to be unidirectional without having to take more elaborate measures.

16. Use of the method and apparatus according to the above claims, wherein the deflection thrusts are delivered to charges that have sufficient motional freedom, making possible the creation of currents, either through an external loop, or internally to the medium.

17. Use of the method and apparatus according to the above claims wherein the charges do not have sufficient motional freedom so the deflection forces are transferred to the frame that houses these charges.

18. Use of the method and apparatus according to the above claims, wherein the deflection forces are exerted upon dipoles (provided that the distance between the poles is far less than half the wavelength of the acting wave), pushing both poles toward the same direction.

19. Use of the method and apparatus according to the above claims wherein the deflection forces are exerted upon resonant oscillations of charges of same polarity, pushing them in opposite directions to each other.

20. The method according to claim no.1, wherein the thrusts are exerted by an alternating electric field that is applied upon a local region that is traversed alternatively by positive and negative charge, or alternatively by charges and holes, or by charged particle waves alternatively interfering constructively and destructively, so that positive electric field always acts on positive charge and negative field always on negative charge, or vice versa, in order to exert repeated synchronized thrusts toward a specific average direction according to the principle of this invention.

21. The method according to claim no.1, wherein a mechanical wave is used, for example a sound wave, exerting repeated synchronized thrusts on a rotating or revolving flat-like object, utilizing only the “push” or only the “pull” parts of the wave's consequent alternations.

22. The method according to claim no. 21, wherein the revolving flat-like object has a curved shape, the curvature having the radius of revolution, for not to create turbulence in the fluid media.

23. The method according to the above claims wherein a partially rectified wave is created passed the interaction region.

24. Use of the method according to claims nos. 1-18, wherein the wave that has participated in the interaction carries non-classical wave attributes, for example an evanescent mode.

25. Use of the method according to claim no. 24 wherein the wave attributes that are described in evanescent mode are subject to amplitude or frequency modulation so as to contain a signal.

26. Method of transforming wave energy into repetitive thrusts according to claim no.1, wherein an exotic wave is used so the cross product interaction that drives the synchronized deflection thrusts operates orthogonally with respect to extra spacetime dimensions (dimensions beyond the conventional four), while in the classical world any produced thrust may become perceivable as some sort of internal force, like possibly a spin-related force, or another quantum force, or a negative-energy force, or even a force relating to the weak interaction.
